(19) United States
(12) Patent Application Publication
(10) Pub. No.: US 2002/0077152 A1
(43) Pub. Date: Jun. 20, 2002

(54) Wireless communication methods and systems using multiple overlapping sectored cells

(76) Inventors: Thomas J. Johnson, Bedford, NH (US); Edward P. Champy III, South Boston, MA (US)

Correspondence Address: Randy J. Pritzker, Wolf, Greenfield & Sacks, P.C., Federal Reserve Plaza, 600 Atlantic Avenue, Boston, MA, 02210-2211, US

(21) Appl. No.: 09/737,511

(22) Filed: Dec. 15, 2000

(51) Int. Cl. H04M 1/00

(52) U.S. Cl. 455/562; 455/272

(57) ABSTRACT

Wireless communication systems and methods using multiple overlapping sectored cells. Two or more cells in which communication services are provided to a number of subscriber stations at least partially overlap in an overlapping region and are each divided into a number of sectors. A first cell uses a first group of channels to communicate with at least some subscriber stations that are located in the first cell, and a second cell uses a second group of channels to communicate with at least some subscriber stations that are located in the second cell. The sectored cells use different communication channels in respective overlapping sectors of the overlapping region. In this manner, one or more first cells may be deployed with one or more second cells either initially or in a modular fashion over time to flexibly accommodate various topological distributions of subscriber stations and varying capacity demands in a wireless communication system without posing significant interference problems. In one example, at least one cell (e.g., a “focal” cell) covers a smaller area than another cell (e.g., a larger “base” cell) with which it at least partially overlaps. One or more such focal cells also may be completely contained within a larger base cell to provide communication services in particular higher density and/or higher capacity demand regions of the base cell.

### FIELD OF THE INVENTION

The present invention relates to wireless communications, and more particularly, to wireless communication methods and systems using multiple overlapping sectored cells.

### DESCRIPTION OF THE RELATED ART

The communications industry has long sought increased capacity communication systems to bring robust communications to the world's population. Much of today's communication traffic is in the form of information carriers that are encoded with digital data representing information to be transported across a communication link. The information transported across the link may include, for example, voice or video information, textual information, program code (e.g., executable software or a portion thereof), or raw data for a particular application.

With the increased use of the Internet and other forms of data communication in recent years, there has been an exponential increase in worldwide data traffic. The increased demand for data communications has essentially outpaced the capacity of many existing systems, creating a need for higher capacity communication systems. The capacity of a given communication link generally refers to the amount of data that can be reliably transported over the link per unit time and is typically measured in terms of data bits per second (bps).

Wireless communication systems are recognized as an effective method of interconnecting users. Wireless communication systems may be preferable, particularly in geographic locations such as congested urban areas, remote rural areas, or areas having difficult terrains, where it may be challenging and/or cost-prohibitive to deploy wire conductors or fiber optics. Rather than transporting information on carriers over a physically tangible communication link such as a wire conductor or fiber optic cable, wireless systems radiate information carriers in open space (i.e., over the air) throughout

In general, the information carriers radiated in wireless communication systems have particular carrier frequencies and predetermined bandwidths within a designated frequency spectrum for a given communication link. In particular, an information carrier may represent a single channel over which to transport information, or may represent or form part of a “channel set” including several channels over which to transport information. For example, a frequency band (i.e., a portion of the designated frequency spectrum) centered around a particular carrier frequency may be divided into a number of smaller bandwidth frequency channels to form a channel set, wherein each channel of the set has a respective information carrier that may carry unique information. Such a scheme commonly is known as Frequency Division Multiple Access (FDMA). Alternatively, an information carrier having a particular carrier frequency may be divided into a number of time slots, wherein each time slot represents a channel that may carry unique information. Such a scheme commonly is known as Time Division Multiple Access (TDMA). Yet other examples of conventional techniques to partition a frequency band into a set of channels include various coding schemes to uniquely identify channels within a set, such as Code Division Multiple Access (CDMA) which uses a unique pseudo-noise digital code (PN code) to encode and decode each channel of a channel set, and various Orthogonal Frequency Division Multiplexing (OFDM) techniques (including VOFDM, COFDM, SC-OFDM, etc.). For purposes of the present disclosure, the term “channel” refers generally to a uniquely identifiable conduit for transporting information on a communication link.

Some proposed solutions for increasing the capacity of wireless communication systems have been directed to point-to-multipoint configurations. In some of these configurations, a communications cell is divided up in a pie-like fashion into a number of essentially wedge-shaped sectors, as shown in FIG. 1. Such systems typically employ a sectored antenna system, which permits the reuse of frequency spectrum amongst multiple sectors within the cell. For example, in the system shown in FIG. 1, adjacent sectors of the cell use information carriers in different frequency bands (e.g., F1-F3 for pair A and F2-F4 for pair B), and alternate sectors use a same pair of carrier frequencies to provide at least one full duplex (i.e., two way) information channel in each sector of the cell. By dividing a cell into a number of sectors and reusing one or more frequency bands in at least some of the sectors, the information carrying capacity of the reused frequency bands in the communication cell is essentially multiplied by the number of sectors in which the bands are used.

### SUMMARY OF THE INVENTION

One embodiment of the invention is directed to a wireless communication system, comprising at least one first sectored cell covering a first cell area, wherein the at least one first sectored cell uses a first group of channels to communicate in the first cell area. The system also includes at least one second sectored cell covering a second cell area, wherein the second cell area overlaps at least a portion of the first cell area and uses a second group of channels to communicate in the second cell area. Each channel of the second group of channels is different than any channel of the first group of channels that is used in the portion of the first cell area that overlaps with the second cell area.

Another embodiment of the invention is directed to a wireless communication system, comprising at least two base stations disposed in a coverage area that includes at least one first sectored cell and at least one second sectored cell which overlaps at least a portion of the at least one first sectored cell. Each cell includes a respective plurality of subscriber stations and includes at least one base station of the at least two base stations disposed approximately at a center of the cell to exchange information over air with at least some of the respective plurality of subscriber stations. Each cell spans up to a 360 degree azimuth angle around the at least one base station. The wireless communication system is constructed and arranged such that the at least one first sectored cell uses a first group of channels to communicate, the at least one second sectored cell uses a second group of channels to communicate, each channel of the second group of channels is different than any channel of the first group of channels that is used in the portion of the at least one first sectored cell that overlaps with the at least one second sectored cell, and the at least one base station in each cell communicates with at least some of the respective plurality of subscriber stations using at least two different channels, wherein adjacent sectors in each cell use different channels.

Another embodiment of the invention is directed to a wireless communication method, comprising acts of covering a first cell area with at least one first sectored cell, using a first group of channels to communicate in the at least one first sectored cell, covering a second cell area with at least one second sectored cell, the second cell area at least partially overlapping a portion of the first cell area, and using a second group of channels to communicate in the at least one second sectored cell, each channel of the second group of channels being different than any channel of the first group of channels that is assigned in the portion of the first cell area that overlaps with the second cell area.

Another embodiment of the invention is directed to a wireless communication method in a wireless communication system including at least two base stations disposed in a coverage area that includes at least one first sectored cell and at least one second sectored cell which overlaps at least a portion of the at least one first sectored cell. Each cell includes a respective plurality of subscriber stations and includes at least one base station of the at least two base stations disposed approximately at a center of the cell to exchange information over air with at least some of the respective plurality of subscriber stations. Each cell spans up to a 360 degree azimuth angle around the at least one base station. The wireless communication method comprises acts of using a first group of channels to communicate in the at least one first sectored cell, using a second group of channels to communicate in the at least one second sectored cell, each channel of the second group of channels being different than any channel of the first group of channels that is assigned in the portion of the at least one first sectored cell that overlaps with the at least one second sectored cell, and communicating between the at least one base station in each cell and at least some of the respective plurality of subscriber stations using at least two different channels, wherein adjacent sectors in each cell use different channels.

Another embodiment of the invention is directed to a wireless communication system, comprising at least two sectored cells that at least partially overlap each other in an overlapping region, the at least two sectored cells using different communication channels in respective overlapping sectors of the overlapping region.

Another embodiment of the invention is directed to a wireless communication method in a wireless communication system comprising at least two sectored cells that at least partially overlap each other in an overlapping region. The wireless communication method comprises an act of using different communication channels in respective overlapping sectors of the overlapping region.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 is a diagram showing an example of frequency spectrum reuse in a sectored cell of a wireless communication system;

FIG. 2 is a diagram showing a wireless communication system according to one embodiment of the invention, based on at least two overlapping sectored cells;

FIG. 3 is a diagram showing a more detailed example of one base station of the wireless communication system shown in FIG. 2, according to one embodiment of the invention;

FIG. 4A is a diagram of the wireless communication system shown in FIG. 2, illustrating a shorthand notation for channel use in sectored cells, according to one embodiment of the invention; and

FIGS. 4B-12 are diagrams showing respective examples of wireless communications systems according to various embodiments of the invention, using the shorthand notation illustrated in FIG. 4A.

### DETAILED DESCRIPTION

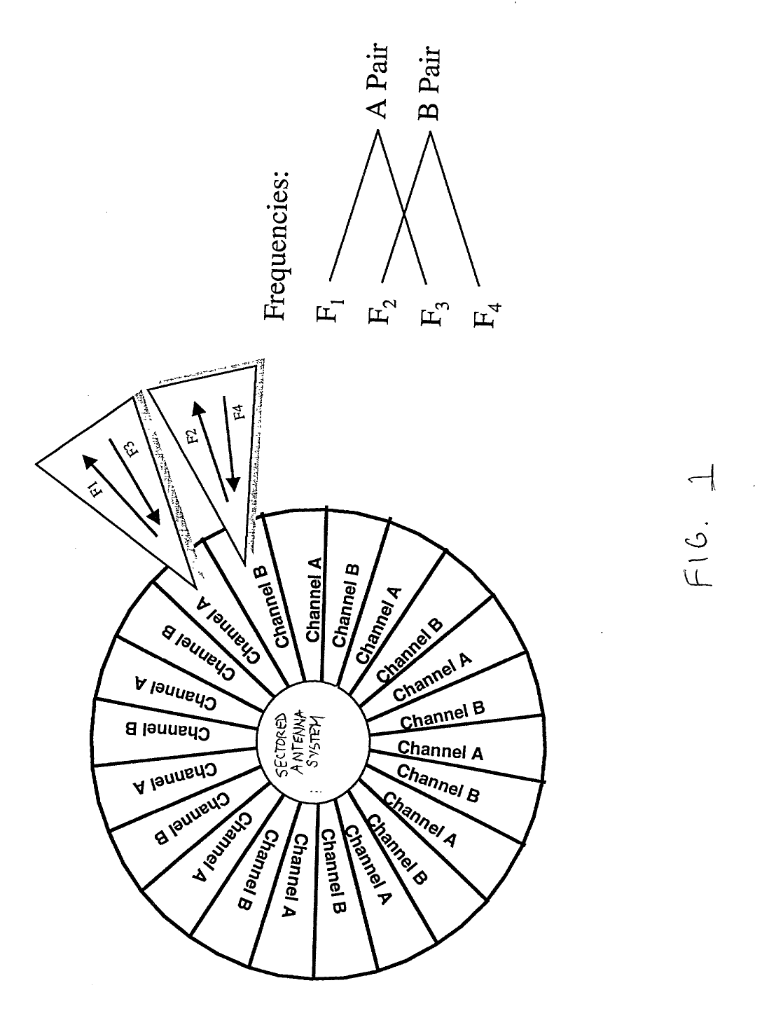

As discussed above, some proposed solutions for increasing the capacity of wireless communication systems involve the concept of a sectored cell, as shown in FIG. 1, in which frequency spectrum is reused amongst multiple sectors of the cell to increase the capacity of the reused spectrum in the cell. In a system employing one or more sectored cells as shown in FIG. 1, Applicants have recognized that at least one significant consideration with respect to providing communication services to a number of subscriber stations (i.e., users) deployed in a sectored cell is the “topological distribution” of the subscriber stations; namely, the respective locations and density of subscriber stations throughout the cell. Generally, in a given sectored cell of a wireless communication system, a number of subscriber stations may be dispersed in a variety of topological distributions. For example, in one region of the cell, several subscriber stations may be located together in close proximity (i.e., a higher density region), while in another region of the cell other subscriber stations may be more sparsely dispersed (i.e., a lower density region). Such higher or lower density regions may fall primarily within one sector of the cell, or may span multiple sectors of the cell.

Applicants also have recognized that another significant consideration with respect to providing communication services in a system employing sectored cells is the relative demand each user may place on the information transporting capabilities of the system. For example, different users may place different demands on the information transporting capacity of one or more communication links in respective sectors of a cell. Additionally, different users often may have capacity requirements that change with time (i.e., dynamic capacity requirements).

The topological distribution and relative capacity demands of subscriber stations deployed throughout a sectored cell each may contribute to the overall capacity requirements of a wireless communication system in a variety of manners. For example, often a higher density region of subscriber stations (e.g., a commercial district of a city) may have a corresponding higher regional capacity demand than a lower density region (e.g., a suburban area). However, it may also be possible that some types of higher density regions in which each respective subscriber station has a relatively low capacity demand (e.g., a residential neighborhood) may have lower regional capacity demands than a lower density region of a cell in which each of a few users has a relatively high demand (e.g., a high tech facility, government complex, university campus, etc.). Additionally, as discussed above, higher or lower density regions having various regional capacity demands may fall primarily within one sector of a cell, or span multiple sectors of a cell. From the foregoing, it should be appreciated that a wide variety of possible topological distributions and diverse capacity demands of users may present significant challenges to an appropriate design for a wireless communication system employing one or more sectored cells.

If the topological distribution and capacity demands of subscriber stations is known at least approximately a priori, however, the design of a wireless communication system employing one or more sectored cells, albeit challenging in some respects, is feasible. For example, various components of the wireless communication system may be designed specifically with particular topological distributions and capacity demands in mind. Some aspects of system design that may affect the ability of the system to meet certain capacity demands include, but are not necessarily limited to, available frequency spectrum for information carriers, antenna system design (e.g., with respect to interference amongst different sectors of a given cell), radiated power of information carriers, modulation and demodulation methods employed to respectively encode information on and decode information from information carriers, and environmental conditions (e.g., climate, terrain, line of sight issues, etc.) that may have an impact on one or more communication links in the system. These and other system design considerations are discussed in detail, for example, in U.S. patent application Ser. No. 09/287,144, entitled “Point-to-Multipoint Two-Way Broadband Wireless Communication System,” which application is hereby incorporated herein by reference.

Applicants have recognized that once a wireless communication system as discussed above is deployed, however, topological distributions and capacity demands in one or more cells may evolve over time, such that the capacity demand in one or more particular regions of a given sectored cell may exceed the capability of the system as originally designed. One possible approach for addressing this situation may be to replace and/or upgrade one or more system components, and/or significantly modify the configuration of the existing system, in an attempt to meet evolving needs. However, replacement and/or upgrade of components or other alterations to the existing system in some cases may be difficult to implement, cause significant disruption of service, and/or be cost-prohibitive. Moreover, even after such modification, continued evolution of topological distributions and/or capacity demands may necessitate one or more future modifications to the system, potentially giving rise to further cost issues and entailing further significant service disruption.

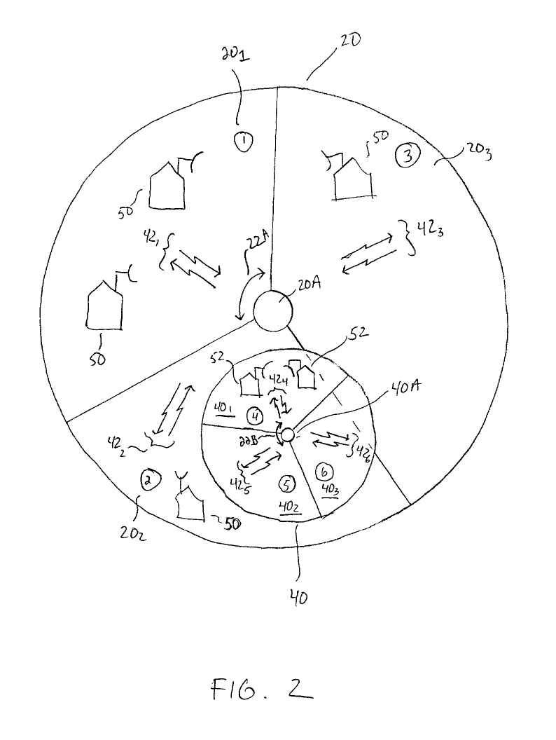

In view of the foregoing, the present invention is directed to a number of solutions for flexibly meeting existing and evolving needs in a wireless communication system that employs one or more sectored cells. In particular, one embodiment of the present invention is directed to wireless communication methods and systems using multiple overlapping sectored cells. For example, in one aspect of the invention (as illustrated in FIG. 2), one or more “focal” or “concentrator” sectored cells (e.g., the cell 40 in FIG. 2) are deployed in relatively higher density and/or higher capacity demand regions of pre-existing or simultaneously-deployed “base” sectored cells (e.g., the cell 20 in FIG. 2) to particularly provide communication services to users in such regions. In this aspect, one or more focal cells may be deployed from time to time in an at least partially overlapping manner with one or more other base cells to meet growing capacity needs without significant interruption or modification of the base cells.

More generally, a wireless communication system according to one embodiment of the invention includes at least two cells that at least partially overlap each other and which are each divided into a number of sectors. In one aspect of this embodiment, at least one of the cells (e.g., a focal cell) covers a smaller area than the other cell (e.g., a larger base cell). In another aspect, one or more focal cells are completely contained within a larger base cell. In yet another aspect, two or more overlapping cells respectively may cover similarly sized areas.

In one embodiment, at least two different communication channels are used in each of two or more at least partially overlapping cells to communicate between a base station in each cell and a number of subscriber stations (i.e., users) located in the respective cells. The different channels used in each cell may be half duplex channels (e.g., transmission of information from the base station to one or more subscriber stations in the cell) or full duplex channels (e.g., two-way information exchange between the base station and one or more subscriber stations in the cell).

In this embodiment, a first cell (e.g., a base cell) uses a first group of channels (e.g., at least two different channels) to communicate with at least some of the subscriber stations that are located in the first cell, and a second cell (e.g., a focal cell) uses a second group of channels (e.g., at least two different channels) to communicate with at least some of the subscriber stations that are located in the second cell. Because the cells at least partially overlap, there may be some subscriber stations that are located in an overlapping region covered by both of the cells (e.g., a portion of the first cell that overlaps with the second cell, or vice versa). Hence, in one aspect of this embodiment, the two overlapping sectored cells do not use any same channels in respective overlapping sectors of the overlapping region. In yet another aspect, each channel of the second group of channels used in the second cell is different than any channel of the first group of channels that is used in the overlapping region. In this manner, one or more subscriber stations and the base station in the second cell are not subject to interference from channels being used in the first cell in the overlapping region. Likewise, according to one aspect, subscriber stations located in the overlapping region may have the option of communicating with the base station of either one of the first cell or the second cell without being subject to interference from channels used in the other cell.

According to one aspect of the invention, one or more focal cells may be deployed with one or more base cells in a modular fashion over time, to flexibly accommodate various topological distributions of subscriber stations and varying capacity demands in a wireless communication system. For example, in one aspect, one or more focal cells each covering a smaller area than a base cell may be deployed to provide communication services in particularly higher density and/or higher capacity demand regions of the base cell. In this aspect, rather than significantly modifying a base station and/or cell configuration of a base cell, one or more subscriber stations in an overlapping region of the cells are easily configured to communicate with one or the other of the base and focal cells.

Additionally, according to another aspect of the invention, the numbers of sectors in both base cells and focal cells may be initially selected or changed over time to accommodate existing and evolving topological distributions of subscriber stations and capacity demands in different regions of respective cells. For example, according to one embodiment, multiple overlapping sectored cells of a wireless communication system (e.g., including one or more base cells and one or more focal cells) are each divided into 3N sectors, where N is an integer. In particular, in one aspect of this embodiment, each cell may be divided into as many as 24 sectors (i.e., N=8). According to another aspect, eight different full duplex channels are each used three times in each cell, and the channels are assigned to the sectors in each cell such that no two adjacent sectors use the same full duplex channel. Additionally, according to yet another aspect of this embodiment, each focal cell of the wireless communication system that at least partially overlaps a base cell uses a same set of eight different full duplex channels that is different from a set of eight different full duplex channels used in the base cell. Such groups of focal cells and base cells may be deployed in extended formations, and be extended as far as desired to cover a wide geographic coverage area having a variety of topological distributions of users and diverse capacity demands throughout the coverage area.

Following below are more detailed descriptions of various concepts related to, and embodiments of, wireless communication methods and systems according to the present invention using multiple overlapping sectored cells. It should be appreciated that various aspects of the invention as discussed above and outlined further below may be implemented in any of numerous ways, as the invention is not limited to any particular manner of implementation. Examples of specific implementations are provided for illustrative purposes only.

FIG. 2 is a diagram showing a wireless communication system having at least two sectored cells 20 and 40 that at least partially overlap, according to one embodiment of the invention. According to one aspect of this embodiment, each of the sectored cells 20 and 40 shown in FIG. 2 may be implemented as described, for example, in U.S. patent application Ser. No. 09/287,144, entitled “Point-to-Multipoint Two-Way Broadband Wireless Communication Systems,” referred to above and incorporated herein by reference.

In particular, each of the cells 20 and 40 shown in FIG. 2 may include a respective plurality of subscriber stations and at least one base station disposed in the cell to communicate over air with the subscriber stations of the cell. For example, as shown in FIG. 2, the cell 20 includes a base station 20A and a plurality of subscriber stations 50, while the cell 40 includes a base station 40A and a plurality of subscriber stations 52. Accordingly, it should be appreciated that different cells of the wireless communication system shown in FIG. 2 may be distinguished at least by their respective base stations. Additionally, although two subscriber stations are shown in each cell of FIG. 2, it should be appreciated that any number of subscriber stations may be dispersed in a variety of manners throughout each of the cells 20 and 40. It should also be appreciated that while FIG. 2 shows the subscriber stations 50 and 52 as buildings having fixed locations, the invention is not necessarily limited in this respect; namely, wireless communication systems according to various embodiments of the invention may be suitable for both mobile and/or fixed subscriber stations dispersed amongst various cells.

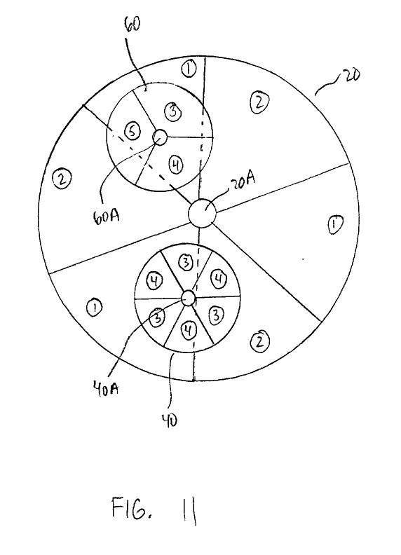

In the wireless communication system shown in FIG. 2, each of the cells 20 and 40 is a sectored cell, in that each of the cell areas covered by the respective cells 20 and 40 is divided into two or more particular geographic regions. For example, FIG. 2 shows that the cell 20 is divided into the sectors 20₁, 20₂, and 20₃, while the cell 40 is divided into the sectors 40₁, 40₂, and 40₃. While FIG. 2 shows three sectors per cell, it should be appreciated that the invention is not limited in this respect, as a given cell may be divided into different numbers of sectors based in part on a particular communications application for which the cell is deployed; additionally, two or more cells of a multiple cell communication system may have different numbers of sectors, as discussed further below in connection with FIG. 11. According to one embodiment of the invention, each sector of a given cell shown in FIG. 2 may be distinguished from other sectors of the cell by one or more particular attributes of one or more communication channels used in the sector, as discussed further below.

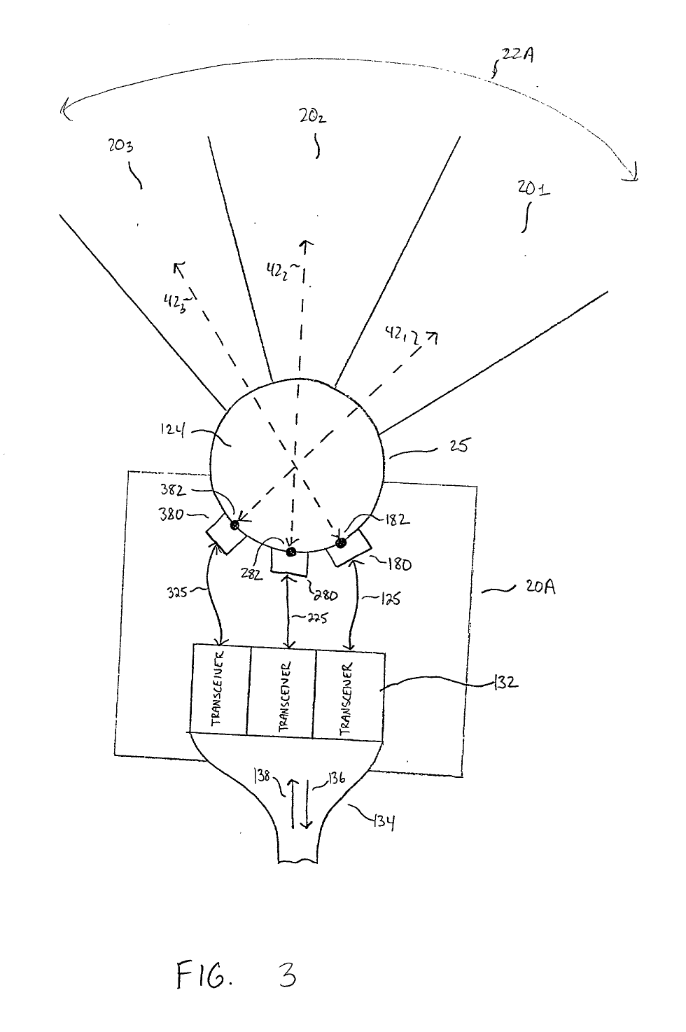

FIG. 3 is a more detailed diagram showing one example of the base station 20A of the sectored cell 20 shown in FIG. 2. A base station similar to that shown in FIG. 3 also may be employed as the base station 40A of the cell 40 shown in FIG. 2. In the embodiment of FIG. 3, the base station 20A includes a sectored antenna system 25 to transmit and receive information on communication channels 42¹, 42₂, and 42₃ (shown symbolically as dashed lines in FIG. 3) that are used to communicate in the sectors 20₁, 20₂, and 20₃, respectively. For ease of illustration, the sectors 20₁, 20₂, and 20₃ are shown in FIG. 3 as covering less than a full 360 degree azimuth angle 22A around the base station 20A. However, it should be appreciated that, as shown in FIG. 2, the sectors 20₁, 20₂, and 20₃ collectively may cover up to a full 360 degree azimuth angle 22A around the base station.

According to one embodiment, the sectored antenna system 25 shown in FIG. 3 may be a lens-based sectored antenna system, as described, for example, in U.S. patent applications having the Ser. Nos. 08/677,413, 08/963,039, and 09/151,036, each of which applications is hereby incorporated herein by reference. In particular, as shown in FIG. 3, according to one embodiment, the sectored antenna system 25 includes a lens 124 having one or more focal points, wherein each focal point corresponds to one sector. For example, in FIG. 3, three focal points 182, 282, and 382 are shown for the lens 124, corresponding to the sectors 20₃, 20₂, and 20₁, respectively.

One example of the lens 124 shown in FIG. 3 that is suitable for purposes of the present invention includes, but is not limited to, a Luneberg-type lens, which may be formed by multiple layers of dielectric materials have different dielectric constants. Luneberg-type lenses were first proposed in the 1940's and are discussed, for example, in the textbook “Mathematical Theory of Optics,” R. K. Luneberg, University of California Press, Berkeley and Los Angeles, 1964, Library of Congress catalog number 64-19010, pages 187-188, hereby incorporated herein by reference.

In particular, a Luneberg lens generally is in the form of a sphere of material having an index of refraction (or dielectric constant) that varies as a function of radius from a center of the sphere to an outer surface of the sphere, according to a particular mathematical relationship. Luneberg lenses possess a unique focusing property; namely, plane waves of radiation incident upon the lens from a distant radiation source are imaged (i.e., focused) at a particular focal point on the outer surface of the lens. The focal point to which the incident radiation is focused is at an end of a diameter of the lens which is parallel to the propagation direction of the incoming wave. Accordingly, as shown in FIG. 3, received information carriers for the channels 42₁, 42₂, and 42₃ respectively are focused to the focal points 382, 282, and 182 by a Luneberg-type lens serving as the lens 124. Conversely, a radiation source located proximate to a focal point on the outer surface of the lens and emitting radiation through the lens ultimately produces a plane wave of radiation propagating in the direction parallel to a diameter of the lens that includes the focal point.

In view of the foregoing, FIG. 3 also shows that the sectored antenna system 25 includes one or more feed devices, located proximate to each focal point of the lens 124, to transmit and/or receive the information carriers for one or more channels in each sector. For example, in FIG. 3, feed device 180 located at focal point 182 transmits and receives the information carriers for the channel 42₃ in sector 20₃. Similarly, feed device 280 located at focal point 282 transmits and receives the information carriers for the channel 42₂ in sector 20₂, and feed device 380 located at focal point 382 transmits and receives the information carriers for the channel 42₁ in sector 20₁. While FIG. 3 shows one feed device to both transmit and receive information carriers in each sector, one or more feed devices may be dedicated to transmitting information carriers in each sector, while one or more other feed devices may be dedicated to receiving information carriers in each sector.

FIG. 3 also illustrates that the base station 20A may include one or more tunable transceivers 132 coupled between the feed devices of the antenna system 25 and a communication link 134. Each transceiver 132 converts information carriers received by the antenna system 25, in one of the sectors 20₁, 20₂, and 20₃, to one or more corresponding information carriers 136 of the communication link 134. Similarly, each transceiver 132 converts one or more information carriers 138 from the communication link 134 to corresponding information carriers for transmission by the antenna system 25 in one of the sectors 20₁, 20₂, and 20₃. As shown in FIG. 3, the base station 20A includes one transceiver 132 for each sector, although according to other embodiments, the base station may include more than one transceiver 132 per sector. While not explicitly shown in FIG. 3, the communication link 134 typically couples the transceivers 132 to one or more modems which modulate and demodulate the information carriers of the communication link 134. According to various embodiments, such modems may form part of the base station 20A or may be located remotely from the base station 20A and coupled to the base station by a variety of media capable of providing for the communication link 134.

In FIG. 3, the sectored antenna system 25 may be located within close proximity of the transceivers 132 so as to minimize any possible signal attenuation. In particular, each transceiver 132 may be coupled to one or more respective feed devices of the antenna system 25 using a low-loss connector. For example, in FIG. 3 the transceivers 132 are shown connected to feed devices 180, 280, and 380 using low-loss cables 125, 225, and 325, respectively, which may be coaxial cables having a short length. Other low-loss methods of connecting the transceivers 132 to the antenna system 25, such as one or more fiber optic cables, may be employed to facilitate a greater separation between the antenna system and one or more transceivers 132.

While the particular example of the base station 20A shown in FIG. 3 includes a lens-based sectored antenna system 25, it should be appreciated that the invention is not limited in this respect. In particular, according to other embodiments, a sectored antenna system of a base station need not employ a lens (e.g., the dielectric lens 124 shown in FIG. 3), but may alternatively employ a variety of feed devices and/or other types of focusing and reflecting elements suitable for transmitting radiation to and/or receiving radiation from a number of sectors of a sectored cell.

With reference again to the cells 20 and 40 shown in FIG. 2, according to one embodiment of the invention, each sector of a given cell may be distinguished from other sectors of the cell by one or more particular attributes of one or more communication channels used in the sector. For example, in the system of FIG. 2, each of the base stations 20A and 40A communicates with the subscriber stations 50 and 52 in their respective cells 20 and 40 using at least three different communication channels, shown as 42₁, 42₂, and 42₃ in the cell 20 and 42₄, 42₅, and 42₆ in the cell 40. A given communication channel may be a half duplex channel (one-way information transport) or a full duplex channel (two-way information transport). In the exemplary system of FIG. 2, the channels 42₁-42₆ are shown as full duplex channels (i.e., as indicated symbolically by the oppositely directed arrows in each sector) to accommodate two-way communications between respective base stations and one or more subscriber stations in a cell.

For purposes of the present discussion, a “communication channel” refers to a uniquely identifiable conduit for transporting information. For example, in the system of FIG. 2, each of the channels 42₁-42₆ used in the two cells 20 and 40 may be uniquely identified by virtue of different carrier frequencies of the information carriers for the channels and/or different polarizations of the information carriers for the channels. Additionally, each channel 42₁-42₆ may represent a different time slot in a series of TDMA (i.e., time division multiple access) channels, or may have a unique code amongst a group of coded channels; for example, each channel 42₁-42₆ may have a unique PN (i.e., pseudo-noise) code amongst a group of CDMA (i.e., code division multiple access). Moreover, various combinations and permutations of the foregoing potentially distinguishing attributes of the channels are possible to uniquely identify each of the channels 42₁-42₆. According to one embodiment of the invention, different channels are distinguished primarily in terms of different carrier frequencies of the information carriers for the channels; however, it should be appreciated that the invention is not limited in this respect, as several distinguishing channel attributes are possible, as discusses above.

According to another embodiment of the invention, each channel 42₁-42₆ shown in FIG. 2 may include a channel set. For example, the channel 42₁ may represent a set of TDMA channels (i.e., time slots) on an information carrier having a particular carrier frequency, or may represent a set of closely spaced FDMA or CDMA (i.e., frequency or coded) channels within a particular frequency band, as well as a set of OFDM channels using, for example, VOFDM, COFDM, or SC-OFDM coding/decoding techniques. Such channel sets may be distinguished from each other in different sectors, for example, by employing different carrier frequencies for TDMA channel sets or different frequency bands for FDMA, CDMA, or OFDM channel sets. Additionally, different channel sets may be uniquely identified from other channel sets by different polarizations of the information carriers for the channel sets, or by combinations of different polarizations and different frequency bands.

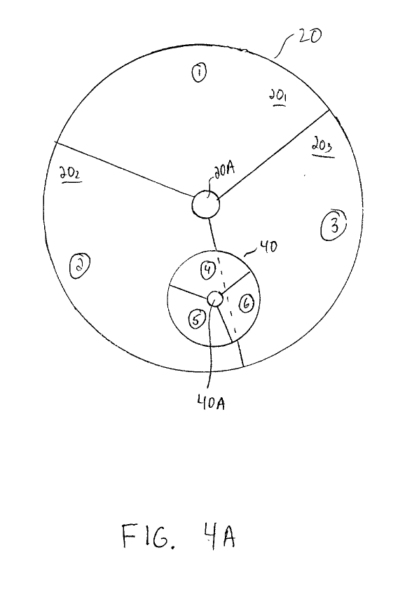

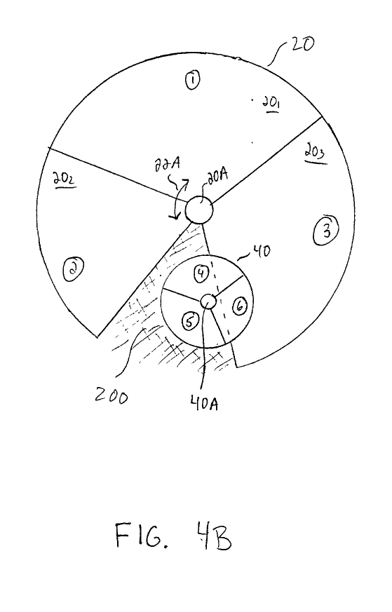

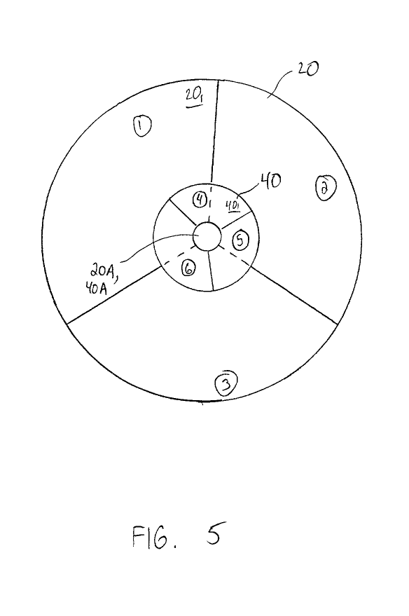

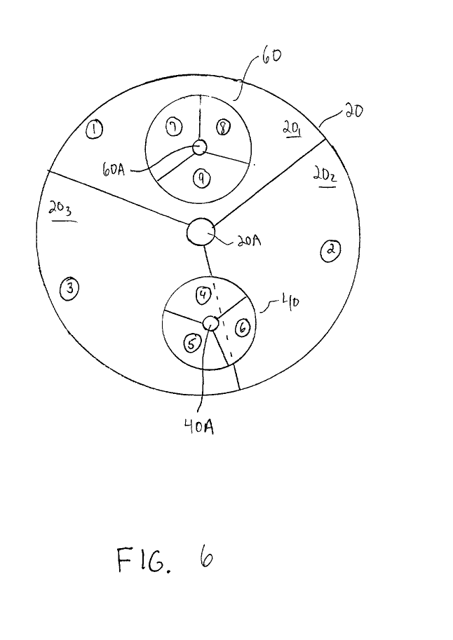

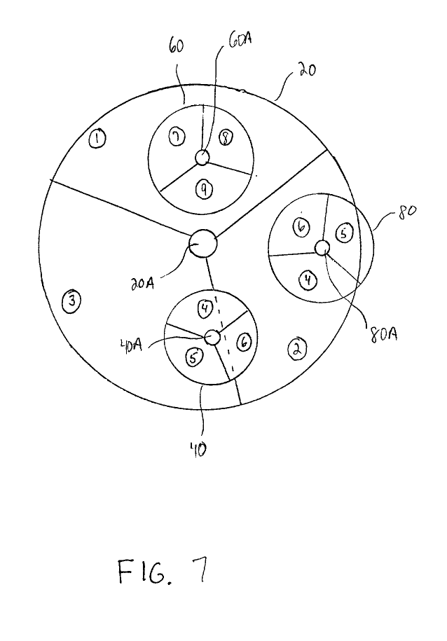

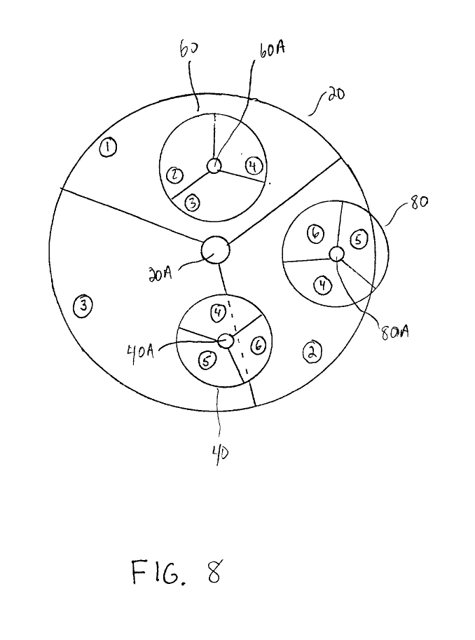

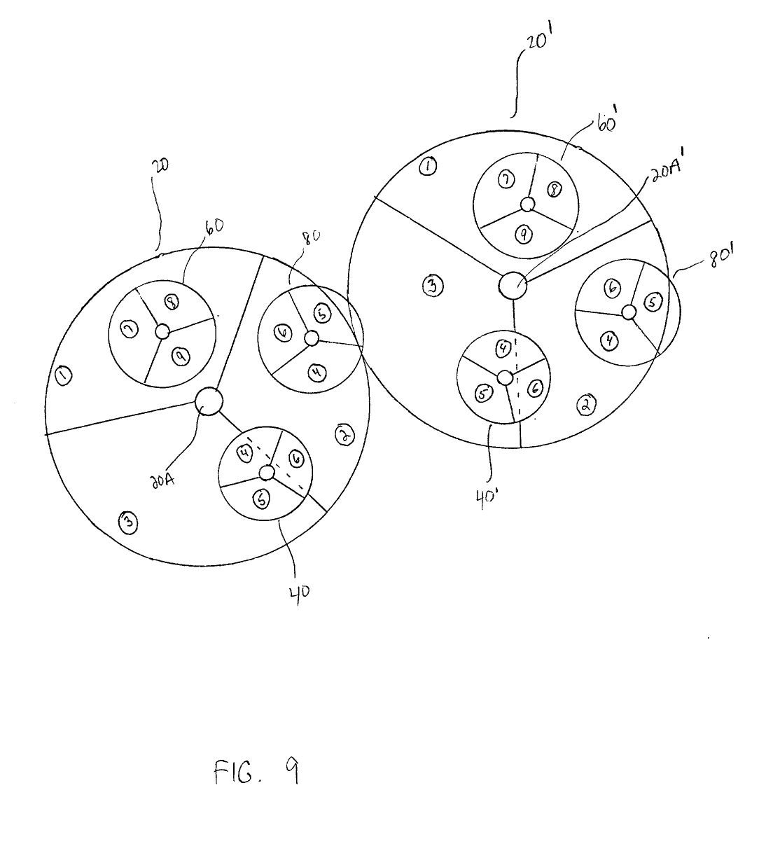

In FIG. 2, a simplified notation is introduced to indicate the “uniqueness” of a given channel (or a given channel set); namely, a particular channel or channel set (i.e., identifiable by frequency, polarization, time slot, code, etc.) is indicated with a specific encircled number. For example, in the cell 20 of FIG. 2, the encircled number “1” in the sector 201 indicates one or more distinct identifying attributes of the channel 421. Similarly, the encircled number “2” in sector 20₂ indicates one or more distinct identifying attributes of the channel 42₂, and the encircled number “3” in sector 20₃ indicates one or more distinct identifying attributes of the channel 42₃. Likewise, in the cell 40 of FIG. 2, the encircled number “4” in the sector 40₁ indicates one or more distinct identifying attributes of the channel 42₄, the encircled number “5” in sector 40₂ indicates one or more distinct identifying attributes of the channel 42₅, and the encircled number “6” in sector 40₃ indicates one or more distinct identifying attributes of the channel 42₆. For example, as discussed above, according to one embodiment, each of the encircled numbers 1-6 may identify one or more unique carrier frequencies of the information carriers for the channels used in the respective sectors. FIG. 4A is a diagram of the wireless communication system shown in FIG. 2, illustrating channel use in the cells 20 and 40 using the simplified notation discussed above. This notation is also used in the subsequent FIGS. 4B-12 in connection with other embodiments of the invention discussed further below.

With reference again to FIG. 2, while FIG. 2 shows each of sectors in the cells 20 and 40 as distinct approximately wedge-shaped geographic regions within a cell, it should be appreciated that each sector may have an arbitrary shape, and that the particular depiction of sectored cells in FIG. 2 is for purposes of illustration only. For example, as discussed above, communication links in wireless communication systems generally are defined by the spatial profile (e.g., extent) of radiated information carriers. In practice, the spatial profiles of information carriers radiated by the base stations 20A and 40A into respective sectors of the cells 20 and 40 shown in FIG. 2 may have some curvature. Additionally, the spatial profile of a given information carrier designated for a particular sector may slightly overlap with the geographic region of one or more neighboring sectors. Accordingly, it should be appreciated that while sectors are depicted herein for purposes of illustration as non-overlapping approximately wedge-shaped geographic regions of a cell, in practice sectors may have a variety of different shapes, and sector boundaries nominally may overlap due to the spatial profiles of information carriers radiated into the sectors.

FIG. 2 also depicts the cell 20 as having an essentially circular shape (i.e., an essentially circular “active cell area”) and spanning a 360 degree azimuth angle 22A around the base station 20A; similarly, the cell 40 is shown in FIG. 2 as having an essentially circular shape and spanning a 360 degree azimuth angle 22B around the base station 40A. However, it should be appreciated that the invention is not limited in this respect, and that such a depiction of cells in FIG. 2 is for purposes of illustration only. In particular, as discussed above, the actual perimeter shape of a given cell in practice may be determined by the sum affect of the respective spatial profiles of information carriers that are radiated in respective sectors of the cell.

For example, according to some embodiments of the invention, in a given cell, information carriers may be radiated by a base station in only a particular geographic region that does not completely surround the base station (i.e., the active cell area may span less than a full 360 degree azimuth angle around the base station). Additionally, a base station in a given cell may radiate information carriers in respective sectors or geographic regions using different respective transmitted power levels; in this case, some information carriers may reach greater radial distances from the base station than other carriers. Accordingly, the radial extent of the cell may be different at different azimuth angles around the base station. From the foregoing, it should be appreciated that a variety of cell shapes are possible according to various embodiments of the invention. For example, FIG. 4B illustrates two cells 20 and 40, wherein the cell 20 spans less than a full 360 degree azimuth angle 22A around the base station and, hence, does not have a circular shape (i.e., the base station 20A in FIG. 4B is constructed and arranged such that radiation is neither transmitted nor received by the base station 20A in the shaded area 200).

Additionally, FIGS. 2 and 4A illustrate the cell 40 as covering an area which is smaller than that covered by the cell 20. However, it should be appreciated that the invention is not limited in this respect, as two or more sectored cells arranged in an at least partially overlapping manner according to other embodiments of the invention respectively may cover similarly sized areas. Similarly, FIGS. 2 and 4A show that the cell 40 is completely contained within the cell 20; again, however, it should be appreciated that the invention is not limited in this respect, as two or more cells may only partially overlap according to other embodiments of the invention, as discussed further below, for example, in connection with FIG. 7.

Furthermore, while FIGS. 2 and 4A show that the base stations 20A and 40A are deployed at respective different geographic locations, FIG. 5 illustrates that the invention is not limited in this respect. In particular, FIG. 5 shows a wireless communication system according to another embodiment of the invention, in which two overlapping cells 20 and 40 are essentially concentric; stated differently, the base stations 20A and 40A are deployed at essentially a same location. Although FIG. 5 shows that the sectors of the cell 20 and the sectors of the cell 40 are not co-aligned, it should be appreciated that the invention is not limited in this respect, as a number of relative sector orientations are possible between the cells 20 and 40 (e.g., the sectors 20₁ and 40₁ may be co-aligned such that they share sector boundaries extending outward from the centrally located base stations 20A and 40A, or alternatively the sectors in each cell may be offset from each other in an arbitrary fashion, as shown in FIG. 5).

With reference again to FIG. 2, according to one embodiment of the invention, the sectored cells 20 and 40 use different communication channels in respective overlapping sectors in a region where the cells overlap. For example, in FIG. 2, an overlapping region of the two cells 20 and 40 includes the entire cell area covered by the cell 40. Within this overlapping region, the sectors 40₁ and 40₃ of the cell 40 each overlaps with the sectors 20₂ and 20₃ of the cell 20; accordingly, since the sectors 20₂ and 20₃ use the channels 2 and 3, respectively, each of the sectors 40₁ and 40₃ do not use the channels 2 and 3 (i.e., instead they use the channels 4 and 6, respectively). Similarly, the sector 40₂ of the cell 40 overlaps only with the sector 20₂ of the cell 20; accordingly, the sector 40₂ does not use the channel 2 which is used in the sector 20₂, but instead uses the channel 5.

The foregoing concept may be extended to several other embodiments of the invention employing a variety of channel use schemes. For example, with reference again to FIG. 4A (which is a diagram similar to FIG. 2 using the simplified channel notation discussed above), according to one aspect of this embodiment, a first group of channels (e.g., including the channels 1, 2, and 3 as shown in FIG. 4A) is used to communicate in the cell 20, and a second group of channels (e.g., including the channels 4, 5, and 6 as shown in FIG. 4A) is used to communicate in the cell 40. In this aspect, each channel of the second group of channels is different than any channel of the first group of channels that is used in a portion of the area covered by the cell 20 that overlaps with the area covered by the cell 40. According to another aspect of this embodiment, each of the base stations 20A and 40A also uses different channels in adjacent sectors in each respective cell 20 and 40.

For example, as shown in FIG. 4A, the cell 40 overlaps the cell 20 in a portion of the cell 20 in which the channels 2 and 3 are used in the respective sectors 20₂ and 20₃. Accordingly, the cell 40 does not use the channels 2 and 3, so as to avoid interference with subscriber stations located in the first cell that use the channels 2 or 3 to communicate with the base station 20A. It should be appreciated that the invention is not limited to the particular channel use scheme illustrated in FIG. 4A, and that numerous other channel use schemes are possible according to other embodiments of the invention, as discussed further below.

As discussed above, according to one embodiment of the invention, one or more cells similar to the cell 40 shown in FIG. 4A may serve as “focal cells” with respect to one or more “base cells” similar to the cell 20 shown in FIG. 4A. In particular, according to one embodiment, one or more focal cells may be deployed in relatively higher density and/or higher capacity demand regions of pre-existing or simultaneously-deployed base cells to particularly provide communication services to users in such regions. In this embodiment, as discussed above and as shown in FIG. 4A, the base cell uses a first group of channels (e.g., 1, 2, and 3) to communicate with at least some of the subscriber stations that are located in the base cell, and the focal cell uses a second group of channels (e.g., 4, 5, and 6) to communicate with at least some of the subscriber stations that are located in the focal cell. Because the focal cell at least partially overlaps with the base cell, there may be some subscriber stations that are located in an overlapping region covered by both the base cell and the focal cell. Hence, in one aspect of this embodiment, each channel of the second group of channels used in the focal cell is different than any channel of the first group of channels that is used in a portion of the base cell that overlaps with the focal cell. In this manner, the subscriber stations and the base station in the focal cell are not subject to interference from channels being used in the overlapping portion of the base cell. Likewise, according to one aspect, subscriber stations located in the overlapping portion of the base cell and the focal cell may have the option of communicating with the base station of either one of the base cell or the focal cell without being subject to interference from channels used in the other cell.

Various channel use schemes similar to that shown in the embodiment of FIG. 4A allow one or more focal cells to be deployed simultaneously and/or from time to time in an at least partially overlapping manner with one or more other base cells. In one aspect, the use of such focal cells in wireless communication systems according to the present invention provides for flexible accommodation of various existing and/or evolving topological distributions of subscriber stations and varying capacity demands without significant interruption of service in, and without significant modification to the components and/or configuration of, the base cells.

For example, in the system of FIG. 4A, according to one embodiment, the base cell 20 originally may have been deployed with a particular number of subscriber stations located in each of the sectors 20₁, 20₂, and 20₃. Over time, however, capacity demands in the geographic region in and around a boundary between the sectors 20₂ and 20₃, for example, may have increased due to either additional subscriber stations being deployed in this region and/or increased demands of individual subscriber stations already deployed in this region. As capacity demands increase in a particular geographic region of a base cell such as the cell 20, a focal cell such as the cell 40 may be deployed in that region to particularly accommodate the increase in capacity demand.

When a focal cell 40 is deployed with a pre-existing base cell 20 in one aspect of the embodiment shown in FIG. 4A, it should be appreciated that at least some subscriber stations located near the boundary of the sectors 20₂ and 20₃ of the base cell (which formerly used the channels 2 or 3 to communicate with the base station 20A) may be reconfigured to communicate with the base station 40A of a newly deployed focal cell 40 using one or more of channels in a second group of channels (i.e., the channels 4, 5, and 6 shown in FIG. 4A). At the same time, other subscribers in other regions of the sectors 20₂ and 20₃ of the base cell 20 may remain essentially unaffected by the deployment of the new cell 40 and the new base station 40A. In many cases, reconfiguring subscriber stations for a focal cell deployment presents appreciably fewer challenges than would modifying the base cell to accommodate increased capacity demands. Accordingly, the use of focal cells as shown in FIG. 4A allows dynamic growth of a communication system and affords significant flexibility.

Based on the model of FIG. 4A, it should be appreciated that a rich variety of possibilities according to the present invention exists for deploying two or more at least partially overlapping sectored cells (e.g., one or more focal cells with one or more base cells) to accommodate a variety of topological distributions of subscriber stations and capacity demands in a wireless communication system. In particular, FIGS. 6-12 illustrate a number of other embodiments of wireless communication systems and methods according to the present invention using multiple overlapping sectored cells with a variety of channel schemes, as discussed further below.

FIG. 6 is a diagram showing a wireless communication system according to another embodiment of the invention, in which two focal cells 40 and 60 having respective base stations 40A and 60A are deployed with a base cell 20 having a base station 20A. In the embodiment of FIG. 6, each of the focal cells 40 and 60 uses channels that are different than any channel used in the base cell 20 in portions of the base cell 20 that respectively overlap with the focal cells 40 and 60. For example, the focal cell 40, which overlaps sectors of the base cell 20 that use the channels 2 and 3, uses the channels 4, 5, and 6. Similarly, the focal cell 60, which overlaps a sector of the base cell 20 that uses the channel 1, uses the channels 7, 8, and 9.

According to one aspect of the embodiment shown in FIG. 6, the focal cells 40 and 60 may be deployed arbitrarily with respect to the location of sector boundaries in the base cell 20 due to the channel scheme discussed above (and other similar channel schemes, discussed further below). For example, the cell 40 is deployed such that it overlaps the sectors 20₂ and 20₃ of the cell 20, whereas the cell 60 is deployed such that it is fully contained within the sector 20₁ of the cell 20. In each case, none of the cells 20, 40, and 60 use channels that potentially may pose interference problems with another of the cells.

While FIG. 6 illustrates two focal cells 40 and 60 which are completely contained within a larger base cell 20, FIG. 7 shows an alternative embodiment in which a third focal cell 80 having a base station 80A only partially overlaps the base cell 20 (i.e., the focal cell 80 is not fully contained within the base cell 20). According to one aspect of this embodiment, any one or more of the cells 40, 60, and 80 shown in FIG. 7 may only partially overlap the base cell 20.

Additionally, FIG. 7 illustrates that the focal cells 40 and 80 may use the same group of channels (e.g., the channels 4, 5, and 6), as these cells do not pose any potential interference problems for each other. In general, according to another aspect of the embodiment shown in FIG. 7, any number of focal cells similar to the cells 40, 60, and 80 deployed in an at least partially overlapping manner with the base cell 20, and in a non-overlapping manner with respect to each other, may use the same group of channels, provided that none of the channels assigned in the focal cells are the same as any channel that is assigned in the base cell in respective portions of the base cell that overlap with the focal cells (e.g., respective overlapping sectors in an overlapping region). For example, while the focal cell 60 in FIG. 7 is shown for purposes of illustration as using the channels 7, 8, and 9, according to another embodiment the focal cell 60 may use the channels 4, 5, and 6, similar to the focal cells 40 and 80 shown in FIG. 7, as these channels would not pose any potential interference problems with the channel 1 used in the portion of the cell 20 which overlaps with the focal cell 60.

FIG. 8 is a diagram similar to FIG. 7 showing yet another alternate choice of channels for the cell 60 based on the discussion immediately above. In particular, FIG. 8 shows that the cell 60 may use the channels 2, 3, and 4, each of which is different than the channel 1 used in the portion of the cell 20 which overlaps with the cell 60. Accordingly, FIG. 8 illustrates that according to some embodiments of the invention, one or more focal cells may use one or more channels that are also used in a base cell, provided that the channels used in the focal cells are different than any channels used in respective portions of the base cell that overlap with the focal cells.

FIG. 9 is a diagram showing a wireless communication system according to yet another embodiment of the invention, in which two or more base cells are deployed in an adjacent manner in a coverage area, and wherein one or more of the base cells is deployed with one or more focal cells that at least partially overlap with one or more of the base cells. In particular, FIG. 9 shows a first base cell 20 deployed with three focal cells 40, 60, and 80, in a manner similar to that shown in FIG. 7. FIG. 9 also shows a second base cell 20′ adjacent to the first base cell 20. The second base cell 20′ is also deployed with three focal cells 40′, 60′, 80′. While FIG. 9 shows two base cells each deployed with three focal cells, it should be appreciated that the invention is not limited in this respect, as any number of base cells may be deployed in an adjacent manner, and any one or more of the base cells thus deployed may be deployed with one or more focal cells which at least partially overlap one or more of the base cells.

In one aspect of the embodiment shown in FIG. 9, the two base cells 20 and 20′ are oriented with respect to each other so as to reduce interference amongst sectors of the respective base cells 20 and 20′ which use one or more same channels. Examples of various orientation schemes for multiple adjacent sectored cells are discussed in greater detail in U.S. patent application Ser. No. 09/546,060, entitled “Wireless Communication Methods and Systems Using Multiple Sectored Cells,” which application is hereby incorporated herein by reference. According to one embodiment, using such orientation schemes to reduce potential interference problems amongst multiple adjacent sectored cells, a number of base cells similar to the cells 20 and 20′ shown in FIG. 9 may be deployed in extended formations which can be extended as far as desired. Additionally, according to one aspect of this embodiment, one or more of the base cells may use a same group of channels. In particular, as illustrated in FIG. 9, both of the cells 20 and 20′ use the channels 1, 2, and 3. In a similar manner, as discussed above in connection with FIG. 7, non-overlapping focal cells in one or more of the base cells may use a same group of channels, as shown in FIG. 9 by the cells 40, 40′, 80, and 80′ (which each uses the channels 4, 5, and 6), and the cells 60 and 60′ (which each uses the channels 7, 8, and 9).

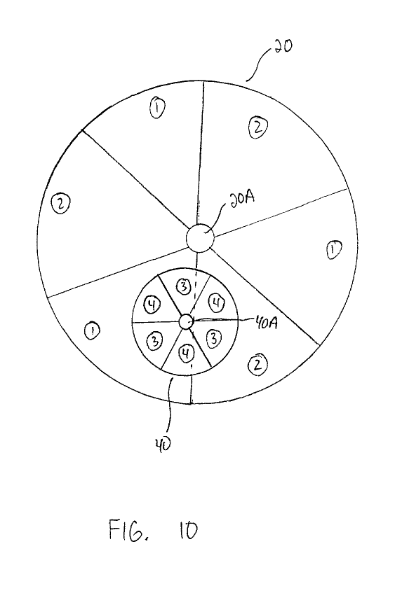

FIG. 10 is a diagram showing a wireless communication system according to yet another embodiment of the invention, in which at least two same channels are used in at least one of a base cell 20 and a focal cell 40 that at least partially overlaps the base cell 20. In particular, FIG. 10 shows that both the base cell 20 and the focal cell 40 are each divided into six sectors. In the base cell 20, the channels 1 and 2 are used in an alternating manner in the sectors of the cell, while the channels 3 and 4 are used in an alternating manner in the sectors of the focal cell 40.

FIG. 11 is a diagram showing yet another embodiment of a wireless communication system according to the invention. In the embodiment of FIG. 11, first and second focal cells 40 and 60 are deployed with the base cell 20. According to the embodiment of FIG. 11, one of the cells 20, 40 and 60 may have a same or different number of sectors than one or more of the other sectored cells deployed therewith. For example, in FIG. 11, while the cells 20 and 40 each have 6 sectors, the cell 60 has three sectors. Again, however, in the embodiment of FIG. 11, overlapping areas of respective sectored cells do not use any same channels.

FIG. 11 also shows that according to one embodiment of the invention, each sectored cell of a wireless communication system may be divided into 3N sectors, where N is an integer, and wherein N may be the same or different amongst a group of cells. For example, for the cells 20 and 40 shown in FIG. 11, N=2, whereas for the cell 60 in FIG. 1,N=1.

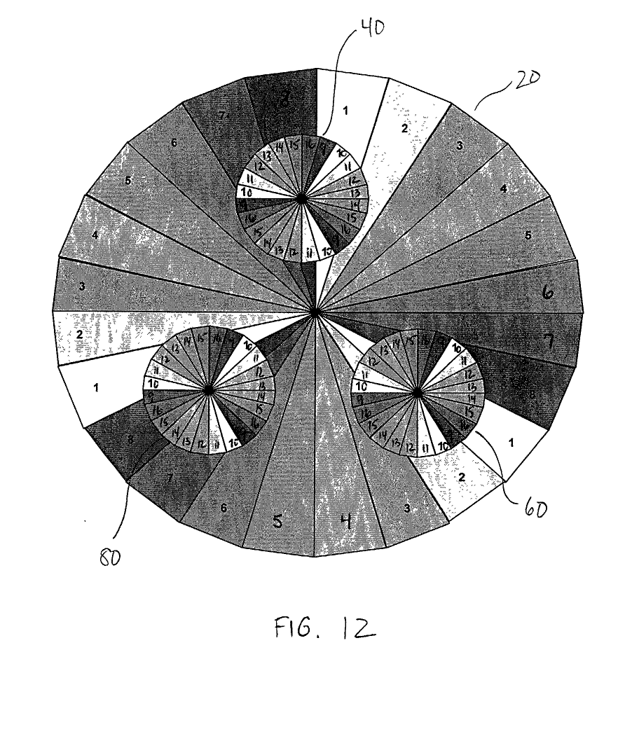

FIG. 12 is a diagram of a wireless communication system according to yet another embodiment of the invention, which further exemplifies the concept of dividing sectored cells of a wireless communication system according to the present invention into 3N sectors. In the embodiment of FIG. 12, a base cell 20 is divided into 24 sectors (N=8) and uses 8 different channels 1-8. Each of the channels 1-8 are used three times in the base cell 20. In the embodiment of FIG. 12, three focal cells 40, 60, and 80 are deployed in the base cell 20, and each of the focal cells 40, 60, and 80 also has 24 sectors and uses the same set of eight different channels 9-16. Again, it should be appreciated, however, that the invention is not limited to the particular channel scheme, number of cells, or number of sectors for each cell shown in FIG. 12, and that the example of FIG. 12 is for purposes of illustration only.

In particular, according to one aspect of the embodiment shown in FIG. 12, each of the cells 20, 40, 60, and 80 need not have an identical (e.g., sequential) ordering of the different channels in the cells. For example, in this aspect, although not explicitly shown in FIG. 12, one of the cells may follow a sequential channel sequence in successive neighboring sectors (e.g., 1, 2, 3, 4, . . . as shown in FIG. 12), while another of the cells may follow a different arbitrary channel sequence (3, 1, 7, 4 . . . ) in successive neighboring cells. In another aspect, each cell of the embodiment shown in FIG. 12 may follow a unique arbitrary channel sequence in successive neighboring cells. According to yet another aspect of the embodiment shown in FIG. 12, as discussed above, the illustrated cell formation may be repeated in an extended formation (i.e., similar to that shown in FIG. 9), and may be extended as far as desired.

From the foregoing embodiments, it should be appreciated that a rich variety of overlapping sectored cell configurations are possible according to various embodiments of the invention. Additionally, it should be appreciated that, in general, the concept of using different channels in respective overlapping sectors of overlapping regions of two or more sectored cells may be extended to three or more mutually overlapping cells (e.g., a focal cell serving as a base cell for another focal cell).

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A wireless communication system, comprising:
at least one first sectored cell covering a first cell area, the at least one first sectored cell using a first group of channels to communicate in the first cell area; and
at least one second sectored cell covering a second cell area, the second cell area overlapping at least a portion of the first cell area and using a second group of channels to communicate in the second cell area, each channel of the second group of channels being different than any channel of the first group of channels that is used in the portion of the first cell area that overlaps with the second cell area.

2. The wireless communication system of claim 1, wherein the second cell area is smaller than the first cell area.

3. The wireless communication system of claim 1, wherein at least one of the at least one first sectored cell and the at least one second sectored cell spans a 360 degree azimuth angle.

4. The wireless communication system of claim 3, wherein at least one of the first cell area and the second cell area has an approximately circular shape.

5. The system of claim 1, wherein each channel of the first and second groups of channels is a full duplex channel.

6. The system of claim 1, wherein each of the first and second groups of channels includes channels having at least one of different carrier frequencies, different polarizations, different time slots, and different codes.

7. The system of claim 6, wherein each of the first and second groups of channels includes at least three channels having at least one of different carrier frequencies, different polarizations, different time slots, and different codes.

8. The system of claim 6, wherein at least one of the first group of channels and the second group of channels includes at least two channels having at least one of same carrier frequencies, same polarizations, same time slots, and same codes.

9. The system of claim 1, wherein at least one channel of the first and second groups of channels is a channel set, the at least one channel set including at least one of a plurality of frequency channels, a plurality of time slot channels, and a plurality of coded channels.

10. The system of claim 9, wherein:
each channel of the first and second groups of channels is a channel set;
each channel set of the first group of channels is uniquely identified from at least one other channel set of the first group of channels as having at least one of a different frequency band and a different polarization than the at least one other channel set of the first group of channels; and
each channel set of the second group of channels is uniquely identified from at least one other channel set of the second group of channels as having at least one of a different frequency band and a different polarization than the at least one other channel set of the second group of channels.

11. The system of claim 10, wherein at least one of the first group of channels and the second group of channels includes at least two channel sets having at least one of a same frequency band and a same polarization.

12. The system of claim 11, wherein the at least two channel sets have the same frequency band and the same polarization.

13. The system of claim 1, wherein the at least one second sectored cell is completely contained within the at least one first sectored cell.

14. The system of claim 13, wherein the at least one first sectored cell and the at least one second sectored cell are essentially concentric.

15. The system of claim 13, wherein the at least one first sectored cell and the at least one second sectored cell are not concentric.

16. The system of claim 15, wherein:
the at least one first sectored cell includes a first base station; and
the at least one second sectored cell includes a second base station different from the first base station.

17. The system of claim 1, wherein the at least one second sectored cell includes a plurality of second sectored cells.

18. The system of claim 17, wherein at least two second sectored cells of the plurality of second sectored cells use the same second group of channels.

19. The system of claim 18, wherein each second sectored cell of the plurality of second sectored cells uses the same second group of channels.

20. The system of claim 17, wherein each second sectored cell of the plurality of second sectored cells is completely contained within the at least one first sectored cell.

21. The system of claim 17, wherein none of the plurality of second sectored cells is concentric with the at least one first sectored cell.

22. The system of claim 17, wherein:
the at least one first sectored cell includes a first base station; and
each second sectored cell of the plurality of second sectored cells includes a unique respective base station different from the first base station.

23. The system of claim 1, wherein the at least one first sectored cell includes a plurality of first sectored cells.

24. The system of claim 23, wherein at least two first sectored cells of the plurality of first sectored cells use the same first group of channels.

25. The system of claim 24, wherein each first sectored cell of the at least two first sectored cells includes at least one second sectored cell that at least partially overlaps the first sectored cell.

26. The system of claim 25, wherein each first sectored cell of the at least two first sectored cells includes a plurality of second sectored cells, each second sectored cell of the plurality of second sectored cells at least partially overlapping the first sectored cell.

27. The system of claim 26, wherein at least two second sectored cells of the plurality of second sectored cells in each cell use the same second group of channels.

28. The system of claim 1, wherein the at least one first sectored cell and the at least one second sectored cell have respectively different numbers of sectors.

29. The system of claim 1, wherein the at least one first sectored cell and the at least one second sectored cell have a same number of sectors.

30. The system of claim 1, wherein each of the at least one first sectored cell and the at least one second sectored cell is divided into 3N sectors, N being an integer.

31. The system of claim 30, wherein each of the first and second groups of channels includes at least three channels having at least one of different carrier frequencies, different polarizations, different time slots, and different codes.

32. The system of claim 31, wherein each of the first and second groups of channels includes at least eight channels having at least one of different carrier frequencies, different polarizations, different time slots, and different codes.

33. The system of claim 32, wherein the at least one first sectored cell and the at least one second sectored cell use a same channel sequence of the at least eight different channels in successive sectors of each cell.

34. The system of claim 32, wherein the at least one first sectored cell and the at least one second sectored cell use a different channel sequence of the at least eight different channels in successive sectors of each cell.

35. The system of claim 32, wherein each of the at least one first sectored cell and the at least one second sectored cell is divided into at least 24 sectors.

36. The system of claim 35, wherein the at least eight different channels in each of the first and second groups of channels are each used at least three times in each of the at least one first sectored cell and the at least one second sectored cell.

37. The system of claim 36, wherein:
the at least one second sectored cell includes a plurality of second sectored cells;
none of the second sectored cells overlaps with another of the second sectored cells; and
each sectored cell of the plurality of second sectored cells is assigned the same second group of channels.

38. The system of claim 37, wherein each channel of the first and second groups of channels is a channel set, each channel set including at least one of a plurality of frequency channels, a plurality of time slot channels, and a plurality of coded channels.

39. The system of claim 38, wherein:
each channel set of the first group of channels is uniquely identified from at least one other channel set of the first group of channels as having at least one of a different frequency band and a different polarization than the at least one other channel set of the first group of channels; and
each channel set of the second group of channels is uniquely identified from at least one other channel set of the second group of channels as having at least one of a different frequency band and a different polarization than the at least one other channel set of the second group of channels.

40. A wireless communication system, comprising:
at least two base stations disposed in a coverage area that includes at least one first sectored cell and at least one second sectored cell which overlaps at least a portion of the at least one first sectored cell, each cell including a respective plurality of subscriber stations and including at least one base station of the at least two base stations disposed approximately at a center of the cell to exchange information over air with at least some of the respective plurality of subscriber stations, each cell spanning up to a 360 degree azimuth angle around the at least one base station, the wireless communication system being constructed and arranged such that:
the at least one first sectored cell uses a first group of channels to communicate;
the at least one second sectored cell uses a second group of channels to communicate, each channel of the second group of channels being different than any channel of the first group of channels that is used in the portion of the at least one first sectored cell that overlaps with the at least one second sectored cell; and
the at least one base station in each cell communicates with at least some of the respective plurality of subscriber stations using at least two different channels, wherein adjacent sectors in each cell use different channels.

41. The system of claim 40, wherein the at least one second sectored cell covers a smaller cell area than the at least one first sectored cell.

42. The system of claim 40, wherein the at least two base stations each includes a sectored antenna system having a Luneberg-type lens.

43. The system of claim 40, wherein the at least two base stations are disposed at different locations in the coverage area.

44. The system of claim 40, wherein at least one of the first group of channels and the second group of channels includes at least two channels having at least one of same carrier frequencies, same polarizations, same time slots, and same codes.

45. The system of claim 40, wherein:
the at least one second sectored cell includes a plurality of second sectored cells; and
the at least two base stations includes a plurality of base stations, wherein each second sectored cell of the plurality of second sectored cells includes a respective base station of the plurality of base stations.

46. The system of claim 45, wherein:
none of the plurality of second sectored cells overlaps with another of the plurality of second sectored cells; and
at least two second sectored cells of the plurality of second sectored cells use the same second group of channels to communicate.

47. The system of claim 46, wherein each second sectored cell of the plurality of second sectored cells uses the same second group of channels to communicate.

48. The system of claim 45, wherein each second sectored cell of the plurality of second sectored cells is completely contained within the at least one first sectored cell.

49. The system of claim 45, wherein each base station of the plurality of base stations is disposed at a different location in the coverage area.

50. A wireless communication method, comprising acts of:
covering a first cell area with at least one first sectored cell;
using a first group of channels to communicate in the at least one first sectored cell;
covering a second cell area with at least one second sectored cell, the second cell area at least partially overlapping a portion of the first cell area; and
using a second group of channels to communicate in the at least one second sectored cell, each channel of the second group of channels being different than any channel of the first group of channels that is assigned in the portion of the first cell area that overlaps with the second cell area.

51. In a wireless communication system including at least two base stations disposed in a coverage area that includes at least one first sectored cell and at least one second sectored cell which overlaps at least a portion of the at least one first sectored cell, each cell including a respective plurality of subscriber stations and including at least one base station of the at least two base stations disposed approximately at a center of the cell to exchange information over air with at least some of the respective plurality of subscriber stations, each cell spanning up to a 360 degree azimuth angle around the at least one base station, a wireless communication method comprising acts of:
using a first group of channels to communicate in the at least one first sectored cell;
using a second group of channels to communicate in the at least one second sectored cell, each channel of the second group of channels being different than any channel of the first group of channels that is assigned in the portion of the at least one first sectored cell that overlaps with the at least one second sectored cell; and
communicating between the at least one base station in each cell and at least some of the respective plurality of subscriber stations using at least two different channels, wherein adjacent sectors in each cell use different channels.

52. A wireless communication system, comprising:
at least two sectored cells that at least partially overlap each other in an overlapping region, the at least two sectored cells using different communication channels in respective overlapping sectors of the overlapping region.

53. In a wireless communication system comprising at least two sectored cells that at least partially overlap each other in an overlapping region, a wireless communication method comprising an act of:
using different communication channels in respective overlapping sectors of the overlapping region.
